(19) United States
(12) Patent Application Publication
(10) Pub. No.: US 2009/0171945 A1
(43) Pub. Date: Jul. 2, 2009

(54) METHOD FOR SEARCHING DATA

(75) Inventors: Yan-Ru Li, Taipei County (TW); Leuo-Hong Wang, Taipei County (TW); Chao-Fu Hong, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ALETHEIA UNIVERSITY, Taipei County (TW)

(21) Appl. No.: 12/136,056

(22) Filed: Jun. 10, 2008

(30) Foreign Application Priority Data
Dec. 31, 2007 (TW) 96151531

(51) Int. Cl. G06F 17/30

(52) U.S. Cl. 707/5; 707/E17.082

(57) ABSTRACT

A method for searching data from a database is provided. The method comprises steps of determining a data set from the database according to a searching target. The data set includes several documents related to the searching target. Then, a content of each of the documents is analyzed to generate a queue of term frequency. Thereafter, according to the queue of the term frequency, a low frequency keyword candidate list is generated. Furthermore, according to the low frequency keyword candidate list and the queue of the term frequency, an effective keyword list is generated. Then, according to the effective keyword list, a document searching result is determined and the document searching result lists several documents in relation to the searching target in the database.

### CROSS-REFERENCE TO RELATED APPLICATION

This application claims the priority benefit of Taiwan application serial no. 96151531, filed on Dec. 31, 2007. The entirety of the above-mentioned patent application is hereby incorporated by reference herein and made a part of this specification.

### BACKGROUND OF THE INVENTION

1. Field of the Invention

The present invention relates to a method for searching data, and in particular, to a method of searching data by using a high frequency keyword and a low frequency keyword at the same time.

2. Description of Related Art

In general, when searching documents (e.g. searching patents from a patent database), keywords are determined according to index numbers and experts' experiences. Most of patent searching strategies can help users to search, analyze and utilize patents effectively. Nowadays, all countries in the world open their patent databases; however, in addition to providing all kinds of columns for the users to fill in searching information, how to use the correct patent searching strategy to search the patents/information is an important issue needed to be solved.

Usually, the documents or patents are searched by the keywords. However, the searching result may be affected by personal/subjective reasons. Moreover, words/terms used in some of the documents in the database may affect the accuracy of the searching result due to the personal/subjective reasons. For example, authors/inventors may use different words/terms because of their habits or culture backgrounds.

Therefore, if the documents in the database are searched only by using commonly-used keywords, only the documents having the commonly-used keywords can be searched out. However, if some documents in the same technical field use different words, the documents can not be searched out, or they are in the aftermost part of the searching result. Thereby, some significant documents or patents are omitted in the searching result, and thus users can not easily find out the trend in the technical field or in the industry.

### SUMMARY OF THE INVENTION

The present invention is directed to a method for searching data. The method can provide a searching term including a high frequency keyword and a low frequency keyword.

The present invention is further directed to a method for searching data. By utilizing a custom correlation of words and by utilizing coexistence between the words and a high frequency keyword, the method performs weighted calculation to retrieve other relevant low frequency keywords, and thereby the accuracy of searching the data is increased.

The present invention provides a method for searching data from a database. The method includes determining a data set from the database according to a searching target, wherein the data set includes a plurality of documents in relation to the searching target. Next, a content of each of the documents is analyzed to generate a queue of term, frequency of the documents, wherein the queue of the term frequency lists a plurality of terms ranked in an order of use frequency corresponding to each of the terms, from the highest use frequency to the lowest use frequency. Then, a low frequency keyword candidate list is generated from the queue of the term frequency according to the queue of the term frequency. After that, an effective keyword list is generated according to the low frequency keyword candidate list and the queue of the term frequency. Finally, a document searching result is determined according to the effective keyword list, wherein the document searching result lists a plurality of documents stored in the database.

According to one embodiment of the present invention, in the method for searching the data, the database includes a patent database, an essay database or a literature database.

According to one embodiment of the present invention, in the method for searching the data, the searching target is selected from a group consisting of a patent art index number, a literature index number, an author/inventor's name, and an assignee's name.

According to one embodiment of the present invention, in the method for searching the data according to claim 1, a method of generating the low frequency keyword candidate list comprises performing weighted calculation on the terms in the queue of the term frequency according to a custom parameter set. The custom parameter set includes an author/inventor's name, a publisher's name, an inventor's name, a name of a patent applicant, a name of a patent agent, a nationality of a country of publication, a nationality of a patent application, and a nationality of patent priority. Moreover, the weighted calculation includes assigning a weighted value to each of the terms according a correlation between each of the words and the custom parameter set. Then, the terms processed by the weighted calculation are re-arranged in order to generate the low frequency keyword candidate list, wherein a correlation between each of the terms in the low frequency keyword candidate list and the custom parameter set satisfies a high unity correlation condition.

According to one embodiment of the present invention, in the method for searching the data, the step of generating the low frequency keyword candidate list further comprises a step a of determining a portion of the terms from the queue of the term frequency to constitute a selected keyword list, wherein each term in the portion of the terms is a high frequency keyword. Next, in a step b, a correlation between each of the terms in the queue of the term frequency and the custom parameter set is established. Then, in a step c, the low frequency keyword candidate list is determined based on the selected keyword list and the correlations, wherein a low correlation is found between each of the terms in the low frequency keyword candidate list and each of the high frequency keywords in the selected keyword list. Furthermore, the step of generating the effective keyword list further includes a step d of determining a low frequency keyword from the low frequency keyword candidate list to add the low frequency keyword into the selected keyword list. After that, the step c and the step d are repeated in sequence until none of the terms exists in the low frequency keyword candidate list, and then the selected keyword list is used to be the effective keyword list.

The present invention provides a method for searching data from a database. The method includes determining a data set from the database according to a searching target, wherein the data set includes a plurality of documents in relation to the searching target. Then, a term/phrase segment analysis is performed in order to generate a queue of term frequency of the documents, wherein the queue of the term frequency lists a plurality of terms. After that, a portion of the terms is determined from the queue of the term frequency to constitute a selected keyword list, wherein each of the terms in the selected keyword list is a high frequency keyword. Thereafter, a weighted calculation is performed on the terms in the queue of the term frequency according to each of the high frequency keywords in order to determine a portion of the terms from the queue of the term frequency to constitute a low frequency keyword candidate list. Afterwards, a keyword refresh operation is performed in order to determine at least one of the terms from the queue of the low frequency keyword candidate list to add it into the selected keyword list. Then, the weighted calculation and the keyword refresh operation are repeated in sequence until none of the terms exists in the low frequency keyword candidate list, and thereby the selected keyword list becomes an effective keyword list. Finally, a document searching result is determined according to the effective keyword list, wherein the document searching result lists a plurality of documents stored in the database.

According to one embodiment of the present invention, in the method for searching the data, the terms in the queue of the term frequency are ranked in an order of use frequency corresponding to each of the terms, from the highest use frequency to the lowest use frequency.

According to one embodiment of the present invention, in the method for searching the data, the weighted calculation includes a coexistence weighted value factor. When a coexistence frequency between the term and the high frequency keywords is lower, the coexisting weighted value factor is larger. Moreover, when a coexistence frequency between the term and the high frequency keywords is higher, the coexisting weighted value factor is lower.

According to one embodiment of the present invention, in the method for searching the data, wherein the weighted calculation comprises determining a custom weighted value factor for each of the terms according to a custom parameter set. A custom parameter set corresponding to the custom weighted value factor includes an author/inventor's name, a publisher's name, an inventor's name, a name of a patent applicant, a name of a patent agent, a name of a country of publication, a nationality of a patent application, and a nationality of patent priority. Furthermore, when a unity correlation between the term and the custom parameter set is higher, the custom weighted value factor of the term is larger. In addition, when a unity correlation between the term and the custom parameter set is lower, the custom weighted value factor of the term is lower.

The present invention utilizes a word/phrase segment analysis technique in data mining to analyze occurrence frequency of the words/phrases in the contents of the documents in the database or the data set. The weighted calculation is performed according to the high frequency keyword to retrieve significant rare words. Finally, by utilizing the effective keyword list constituted by the high frequency keyword and the low frequency keyword, all of the documents in relation to the searching target are searched out without omission.

In order to the make the aforementioned and other objects, features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow chart illustrating a method for searching data according to one embodiment of the present invention.

FIG. 2 is a flow chart illustrating steps of generating a low frequency keyword candidate list and an effective keyword list according to another embodiment of the present invention.

### DESCRIPTION OF EMBODIMENTS

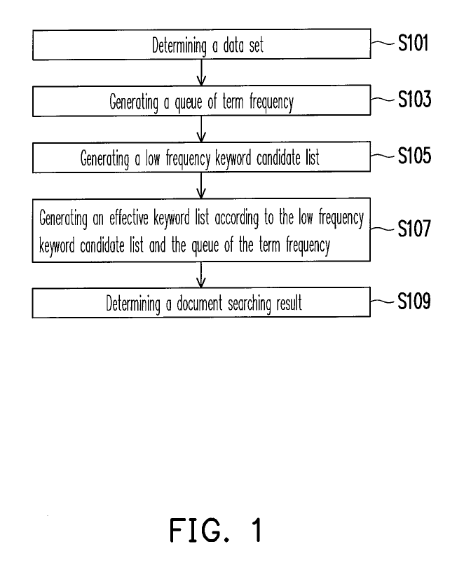

FIG. 1 is a flow chart illustrating a method for searching data according to one embodiment of the present invention. Please refer to FIG. 1. First, in a step S101, a data set is determined from a database according to a searching target, wherein the data set comprises a plurality of documents in relation to the searching target. Moreover, the database includes a patent database, an essay database or a literature database. Furthermore, the searching target includes a technical field, such as one selected from a group consisting of a patent art index number, a literature index number, an author/inventor's name, and an assignee's name.

After that, in a step S103, a content of each of the documents is analyzed, and a queue of term frequency of the documents in the data set is generated. In other words, a word/phrase segment analysis is performed on each of the documents in order to gather statistics for occurrence frequency of each of the terms in the documents. The queue of the term frequency lists a plurality of terms ranked in an order of use frequency corresponding to each of the terms, from the highest use frequency to the lowest use frequency.

In one embodiment, when the searching target is in relation to a digital video disc (DVD) field, thousands of patents and laid-open applications are searched out from the database (e.g. an official patent database of United State Patent and Trademark Office (USPTO)). Then, in a step S103, the term frequency in relation to each of the patents and the laid-open applications is analyzed, and thereby a queue of term frequency listing the terms ranked in an order of use frequency corresponding to each of the terms, from the highest use frequency to the lowest frequency, is generated, wherein most-frequently-used technical terms in relation to the DVD field, such as “optical disc”, “optical disk” and “recording medium”, are arranged in a foremost part of the queue of the term frequency. In other words the above-mentioned technical terms belong to a high frequency keyword group. On the other hand, seldom-used technical terms, such as “storage medium”, “optical record carrier”, “recording disk”, and etc., are arranged in an aftermost part of the queue of the term frequency. In other words, these technical terms belong to a low frequency keyword group.

Then, in a step S105, a low frequency keyword candidate list is generated from the queue of the term frequency according to the queue of the term frequency.

In one embodiment, a method of generating the low frequency keyword candidate list includes performing weighted calculation on the terms according to a custom parameter set in the queue of the term frequency. The custom parameter set includes an author/inventor's name, a publisher's name, an inventor's name, a name of a patent applicant, a name of a patent agent, an assignee's name, a name of a country of publication, a nationality of a patent application, and a nationality of patent priority. In the embodiment, the weighted calculation includes assigning a weighted value to each of the terms according to a correlation between each of the terms and the custom parameter set. Then, the terms processed by the weighted calculation is re-arranged to generate a low frequency keyword candidate list. Further, a correlation between each of the terms in the low frequency keyword candidate list and the custom parameter set satisfies a high unity correlation condition. The correlation between the terms and the custom parameter set is established to sort out high frequency terms; however, when a culture background of the user, or a user (e.g. the author/inventor, the publisher, the inventor, the patent applicant, the patent agent, the assignee) who uses the terms (the technical terms or words) has unity, a high unity correlation condition is satisfied between the terms and the custom parameter set even if the terms are not used most frequently, wherein unity means that the words are used frequently in most of the documents in the same technical field because the users have similar customs or backgrounds. When the unity correlation between the term and the custom parameter set is higher, the custom weighted value factor of the term is higher. After performing the weighted calculation, the terms processed by the weighted calculation are re-arranged. The technical terms which belong to a low frequency keyword group in the queue of the term frequency, such as storage medium, optical record carrier and recording disk, are arranged in the foremost part of the low frequency keyword candidate list because these terms have the high unitary correlation with the custom parameter set.

After that, referring to FIG. 1, after the low frequency keyword candidate list is generated, an effective keyword list is generated in a step S107 according to the low frequency keyword candidate list and the queue of the term frequency. In other words, the effective keyword list is generated by searching and selecting names, the technical terms or the words in relation to the searching target from the low frequency keyword candidate list and the queue of the term frequency. A method of searching and selecting the terms in relation to the searching target from the low frequency keyword candidate list and the queue of the term frequency includes, for example, selecting the terms by a user or selecting the terms according to a customized condition.

A method of determining the low frequency keyword includes directly performing the weighted calculation to establish the correlation between the queue of the term frequency and the custom parameter set in order to obtain the low frequency keyword candidate list. However, the method of generating the low frequency keyword candidate list according to the present invention is not limited by the above-mentioned. Moreover, the method of generating the effective keyword list includes searching and selecting the terms, in relation to the searching target, from the low frequency keyword candidate list and the queue of the term frequency in order to generate the effective keyword list. However, the present invention is not limited by the above-mentioned regarding the method of generating the effective keyword list.

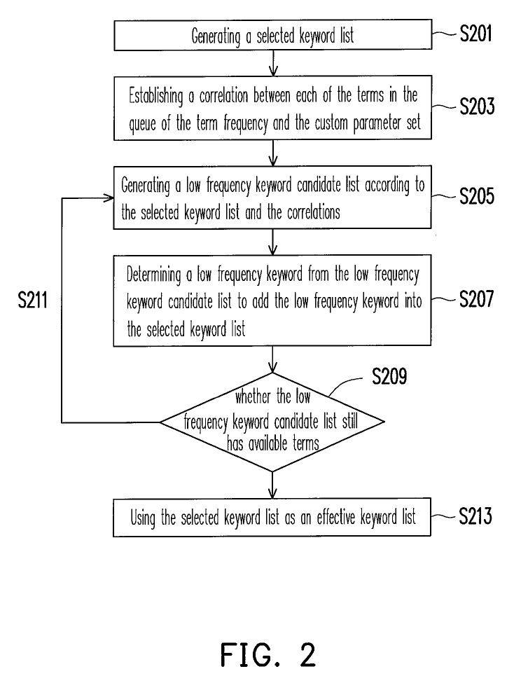

FIG. 2 is a flow chart illustrating steps of generating a low frequency keyword candidate list and an effective keyword list according to another embodiment of the present invention. Referring to FIG. 2, in another embodiment, the steps of generating the low frequency keyword candidate list include a step S201 of determining a portion of the terms from the queue of the term frequency to generate a selected keyword list. Each of the terms in the selected keyword list is in relation to the searching target and is the high frequency keyword in the high frequency keyword group.

After that, in steps S203 and S205, the weighted calculation is performed to determine a portion of the terms from the queue of the term frequency in order to generate a low frequency keyword candidate list. The weighted calculation includes a custom weighted value factor and a coexistence weighted value factor.

First, in the step S203, a correlation between each of the terms in the queue of the term frequency and the custom parameter set is established. In other words, custom weighted calculation of a custom weighted value factor of each of the terms is determined according to the custom parameter set in the above-mentioned embodiment. In other words, when the unity correlation between the term and the custom parameter set is higher, the custom weighted value factor of the term is higher. On the contrary, when the unity correlation between the term and the custom parameter set is lower, the custom weighted value factor of the term is lower. The method of performing a weighted calculation on the terms in the queue of the term frequency in the step S203 is the same as that in the step S105, and therefore the detailed descriptions are omitted. In addition, the custom parameter set in the step S203 is the same as that in the step S105, and therefore, the detailed descriptions are omitted.

Next, in the step S205, a low frequency keyword candidate list is determined based on the selected keyword list and the correlation between each of the terms and the custom parameter set, wherein each of the terms in the queue of the low frequency keyword candidate list is a low frequency keyword, and a low correlation is found between each of the low frequency keywords and each of the high frequency keyword in the selected keyword list. That is to say, in the step S205, according to the correlation between each of the terms and each of the high frequency keyword in the selected keyword list, coexistence weighted calculation is further performed on each of the terms processed by the custom correlation weighted calculation. In the embodiment, the coexistence weighted calculation includes assigning another weighted value (i.e. the coexistence weighted value factor) to each of the terms processed by the weighted calculation according the frequency that each of the terms coexists with each of the high frequency keywords in the selected keyword list at the same time in the same document. The weighted value assigned to the term is higher when the coexistence frequency between a term in the queue of the term frequency and each of the high frequency keywords in the selected keyword list is lower (i.e. the correlation is lower). That is to say, when the coexistence frequency between the term and the high frequency keyword is lower, the coexistence weighted value factor of the term is larger. On the contrary, the weighted value assigned to the term is lower when the coexistence frequency between a term in the queue of the term frequency and each of the high frequency keywords in the selected keyword list is higher (i.e. the correlation is higher). That is to say, when the coexistence frequency of the term and the high frequency keyword is higher, the coexistence weighted value factor is lower.

Therefore, after re-arranging the terms processed by the weighted calculation, the above-mentioned terms, “storage medium” and etc., belong to the low frequency keyword group in the queue of term frequency because the low coexistence frequency between these terms and each of the high frequency keywords in the keyword list is low, and thereby these terms are arranged in the foremost part in the low frequency keyword candidate list.

After that, referring to FIG. 2, after generating the low frequency keyword candidate list, the step of generating the effective keyword list further includes a step S207. In the step S207, a keyword refresh operation is performed to determine a low frequency keyword from the low frequency keyword candidate list to add the low frequency keyword into the selected keyword list. In the embodiment, “storage medium” is not only arranged in the foremost part of the low frequency keyword candidate list, but also in relation to the DVD technical field of the searching target, so that the low frequency keyword “storage medium” can be selected and added into the selected keyword list. The step of determining the low frequency keyword to add it into the selected keyword list includes, for example, selecting the terms by the user or selecting the terms according to a customized condition. The customized condition is, for example, a particular keyword or a particular keyword combination.

After that, still referring to FIG. 2, in a step S209, it is determined whether the low frequency keyword candidate list still has available terms, namely, terms or words in relation to the technical field of the searching target. If it is determined that the low frequency keyword candidate list still has terms or words in relation to the technical field of the searching target, the steps S205 and S207 are repeated in sequence in a step S211 until there are no terms or words in relation to the technical field of the searching target, and thereby the selected keyword list is used as an effective keyword list (S213).

That is to say, in this embodiment, the selected keyword list is determined at first. In addition to the custom correlation weighted calculation, still another weighted calculation is performed on each of the terms in the queue of the term frequency according to the correlation between each of the terms and the selected keyword. Moreover, by continuously performing loop operations (the steps S205 and S207), the effective keyword list can be generated finally.

Then, after the step S107, a document searching result is determined according to the effective keyword list in a step S109. That is to say, the document searching result listing the documents in relation to the searching target is determined from the data base or the data set by using the effective keyword list as various keywords for searching the documents, wherein the document searching result lists a plurality of documents stored in the database.

In summary, according to the present invention, the method for searching the data utilizes a word/phrase segment analysis technique in data mining to analyze the occurrence frequency in relation to the words/phrases in the contents of the documents in the database or the data set. The weighted calculation is performed according to the high frequency keyword to retrieve significant rare words. Finally, by utilizing the effective keyword list constituted by the high frequency keyword and the low frequency keyword, all of the documents in relation to the searching target are searched out without omission. Therefore, even the technical terms, in relation to the searching target, used in the documents are not commonly-used terms because of the customs or culture backgrounds of the author/inventor, the present invention can utilize the high frequency keyword to find the low frequency keyword. Thereby, the documents having the low frequency keywords can be searched out, and the accuracy of the document searching result can be improved.

Although the present invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed description.

What is claimed is:

1. A method for searching data, the method being suitable for a database, comprising:
determining a data set from the database according to a searching target, wherein the data set comprises a plurality of documents in relation to the searching target;
analyzing a content of each of the documents to generate a queue of term frequency of the documents, wherein the queue of the term frequency lists a plurality of terms ranked in an order of use frequency corresponding to each of the terms, from the highest use frequency to the lowest use frequency;
generating a low frequency keyword candidate list according to the queue of the term frequency;
generating an effective keyword list according to the low frequency keyword candidate list and the queue of the term frequency; and
determining a document searching result according to the effective keyword list, wherein the document searching result lists a plurality of documents stored in the database.

2. The method for searching the data according to claim 1, wherein the database includes a patent database, an essay database or a literature database.

3. The method for searching the data according to claim 1, wherein the searching target is selected from a group consisting of a patent art index number, a literature index number, an author/inventor's name, and an assignee's name.

4. The method for searching the data according to claim 1, wherein a method of generating the low frequency keyword candidate list comprises performing weighted calculation on the terms in the queue of the term frequency according to a custom parameter set.

5. The method for searching the data according to claim 4, wherein the custom parameter set includes an author's name, a publisher's name, an author/inventor's name, a name of a patent applicant, a patent agent, an assignee's name, a name of a country of publication, a nationality of a patent application, and a nationality of patent priority.

6. The method for searching the data according to claim 4, wherein the weighted calculation comprises following steps:
assigning a weighted value to each of the terms according to a correlation between each of the terms and the custom parameter set; and
re-ranking the terms processed by the weighted calculation in order to generate the low frequency keyword candidate list, wherein a correlation between each of the terms in the low frequency keyword candidate list and the custom parameter set satisfies a high unity correlation condition.

7. The method for searching the data according to claim 1, wherein the step of generating the low frequency keyword candidate list further comprises:
a step a. of determining a portion of the terms from the queue of the term frequency to constitute a selected keyword list, wherein each term in the portion of the terms is a high frequency keyword;
a step b of establishing a correlation between each of the terms in the queue of the term frequency and the custom parameter set; and
a step c of determining the low frequency keyword candidate list based on the selected keyword list and the correlations, wherein each of the terms in the low frequency keyword candidate list is a low frequency keyword, and a low correlation is found between each of the low frequency keywords and each of the high frequency keywords in the selected keyword list.

8. The method for searching the data according to claim 7, wherein the step of generating the effective keyword list further comprises:
a step d of determining a low frequency keyword from the low frequency keyword candidate list to add the low frequency keyword into the selected keyword list; and
repeating the step c and the step d in sequence until none of the terms exists in the low frequency keyword candidate list, and then using the selected keyword list to be the effective keyword list.

9. A method for searching data, the method being suitable for a database, comprising:
determining a data set from the database according to a searching target, wherein the data set comprises a plurality of documents in relation to the searching target;
performing a term/phrase segment analysis in order to generate a queue of term frequency of the documents, wherein the queue of the term frequency lists a plurality of terms;
determining a portion of the terms from the queue of the term frequency to constitute a selected keyword list, wherein each of the terms in the selected keyword list is a high frequency keyword;
performing a weighted calculation on the terms in the queue of the term frequency according to each of the high frequency keywords in order to determine a portion of the terms from the queue of the term frequency to constitute a low frequency keyword candidate list;
performing a keyword refresh operation in order to determine at least one of the terms from the queue of the low frequency keyword candidate list to add the term into the selected keyword list;
repeating the weighted calculation and the keyword refresh operation in sequence until none of the terms exists in the low frequency keyword candidate list, and thereby the selected keyword list becomes an effective keyword list; and
determining a document searching result according to the effective keyword list, wherein the document searching result lists a plurality of documents stored in the database.

10. The method for searching the data according to claim 9, wherein the terms in the queue of the term frequency are ranked in an order of use frequency corresponding to each of the terms, from the highest use frequency to the lowest use frequency.

11. The method for searching the data according to claim 9, wherein the weighted calculation comprises a coexistence weighted value factor.

12. The method for searching the data according to claim 11, wherein when a coexistence frequency between the term and the high frequency keywords is lower, the coexistence weighted value factor is higher.

13. The method for searching the data according to claim 11, wherein when a coexistence frequency between the term and the high frequency keywords is higher, the coexistence weighted value factor is lower.

14. The method for searching the data according to claim 9, wherein the weighted calculation comprises determining a custom weighted value factor for each of the terms according to a custom parameter set.

15. The method for searching the data according to claim 14, wherein a custom parameter set corresponding to the custom weighted value factor includes an author/inventor's name, a publisher's name, an inventor's name, a name of a patent applicant, a name of a patent agent, an assignee's name, a name of a country of publication, a nationality of a patent application, and a nationality of patent priority.

16. The method for searching the data according to claim 14, wherein when a unity correlation between the term and the custom parameter set is higher, the custom weighted value factor of the term is higher.

17. The method for searching the data according to claim 14, wherein when a unity correlation between the term and the custom parameter set is lower, the custom weighted value factor of the term is lower.

18. The method for searching the data according to claim 9, wherein the database comprises a patent database, an essay database or a literature database.

19. The method for searching the data according to claim 9, wherein the searching target is selected from a group consisting of a patent art index number, a literature index number, an author/inventor's name, and an assignee's name.
